(19) United States
(12) Patent Application Publication
(10) Pub. No.: US 2020/0023674 A1
(43) Pub. Date: Jan. 23, 2020

(54) WHEEL SYSTEM AND ASSOCIATED TRANSPORT DEVICE

(71) Applicant: KEROSTIN MEDICAL, Riantec (FR)

(72) Inventors: Ursy Bonheur MAKANGA, Pointe-Noire (FR); Victor LAMBERT, Pleurtuit (FR)

(21) Appl. No.: 16/484,209

(22) PCT Filed: Nov. 20, 2017
(86) PCT No.: PCT/EP2017/079722

§ 371 Date: Aug. 7, 2019

(30) Foreign Application Priority Data
Feb. 8, 2017 (FR) 1751036

(51) Int. Cl. B60B 3/08; A61G 5/06; B60B 19/04; B60B 19/02

(52) U.S. Cl. CPC B60B 3/08; A61G 5/061; A61G 5/068; B60B 2900/721; B60B 19/02; B60B 2900/351; B60B 19/04

(57) ABSTRACT

The invention relates mainly to a wheel system (S) intended to be rotationally driven about a central axis (X), comprising two distinct parts (R1, R2) arranged in such a way as to be in pivoting connection with one another about the central axis (X), the wheel system (S) is designed in such a way as to occupy two positions; a first position, referred to as the mounted position, in which the two distinct parts (R1, R2) are superposed, and a second position, referred to as the standard position, in which the two distinct parts (R1, R2) are angularly offset from one another so as to form a disc in the plane (P) perpendicular to the central axis (X), the transition from the mounted position to the standard position being carried out by means of a translational movement, along the central axis (X), of one of the distinct parts (R2) with respect to the other (R1).

It is know from the documents U.S. Pat. No. 2,706,640, FR 2 640 218 and FR 2 502 090 to provide trolleys, or wheelchairs, with wheel systems that facilitate passing obstacles, such as stairs.

Solutions of the prior art consist of complex wheel systems mounted on structures, themselves mounted free to pivot with respect to the trolley or with respect to the wheelchair to be moved. These solutions often increase the weight of the trolley/wheelchair assembly.

One of the aims of the invention consists of proposing a solution to facilitate passing obstacles such as stairs, for a trolley or a wheelchair, without increasing the weight of the structure.

Thus, the invention relates to a wheel system intended to be driven in rotation about an axis called the central axis comprising two separate portions, the two separate portions being arranged to form a pivoted connection with respect to each other about the central axis.

According to the invention, the wheel system is designed so as to occupy two positions, a first position called the raised position wherein the two separate portions are superposed so as to form branches in a plane perpendicular to the central axis, which extend radially from the central axis, one separate portion then entirely covering the other separate portion, and a second position called the standard position wherein the two separate portions are angularly offset from each other about the central axis, so as to form a disc in the plane perpendicular to the central axis, particularly a solid disc, the passage from the raised position to the standard position—and reciprocally from the standard position to the raised position—taking place by way of a translation movement, along the central axis, of one of the separate portions with respect to each other.

The solution of the invention consists of one single wheel system, that is itself composed of two portions movable with respect to each other.

One position of these two portions relative to each other is specifically used for passing over obstacles, for example climbing a flight of stairs. Another position of these two portions relative to each other is used more for standard use, for example for moving in an area free of obstacles.

Furthermore, the wheel system of the invention is articulated about one single central axis, and the passage from one of the two wheel system positions to the other is made through a pivot connection sliding about/along this same central axis.

Therefore, the wheel system of the invention has a simple structure, that is easily integratable into any transport device. In other words, when the wheel system is fitted to a transport device, it facilitates passing over obstacles such as stairs, without increasing the weight of the general structure of this transport device.

According to different embodiments of the invention, that can be adopted together or separately:
the wheel system of the invention further comprises a mechanical and/or electromagnetic device intended to ensure the passage from the raised position to the standard position and/or from the standard position to the raised position,
the wheel system of the invention also comprises an electronic device to control the passage from the raised position to the standard position and/or from the standard position to the raised position,
the two separate portions are different in their shape and dimensions so as to be complementary, particularly in the standard position,
a first of the two separate portions is in the form of an independent cross called the support cross, the support cross comprising a plurality of branches, the branches having a functional profile allowing them to grip and/or accompany a rotational movement of the wheel system, in the raised position, when the wheel system abuts with a riser or stair nosing of a staircase,
said functional profile comprises cavities and reliefs alternating around the periphery of said support cross,
the second of the two separate portions is in the form of an independent cross called the rolling cross, the rolling cross comprising a plurality of branches, the branches being designed to engage with the cavities and the reliefs of the functional profile of said support cross,
the branches of said second separate portion comprise protrusions of material near the distal end thereof intended to fill in the cavities of the functional profile of said first separate portion, particularly when the system is in the standard position,
said first separate portion comprises chamfered edges at the level of the cavities and/or reliefs around the periphery thereof,
one separate portion is mounted on the hub of the other separate portion.

The invention also relates to a transport device equipped with at least one wheel system as described above, the wheel system being assembled along an axis, called the rotation axis of the wheel system of the transport device.

Alternatively, the transport device will be equipped with at least two wheel systems as described above, the wheel systems being assembled along one single axis called the rotation axis of the wheel systems of the transport device, on one single axle or an axle specific to each wheel system.

According to different embodiments of the invention, that can be adopted together or separately:
the transport device of the invention comprises a transport chair for a person with reduced mobility,
the transport device of the invention further comprises a lifting system intended to be activated when passing at least one wheel system from the raised position to the standard position and/or from the standard position to the raised position, particularly so as to facilitate the passage between these two positions, said lifting system being configured to bear on the ground while being activated so as to lift the wheel system above the ground,
the wheel systems are designed to be removably assembled to said transport device,
the transport device of the invention comprises a receptacle intended for the transport of various objects,
the transport device of the invention comprises at least one motor intended to drive the axle(s) of the transport device in rotation.

The invention will be best understood and other aims, details, features and advantages of it will become clearer from the detailed description given below, of at least one embodiment of the invention given purely for illustrative purposes and that is in no way limiting, with reference to the appended schematic drawing:

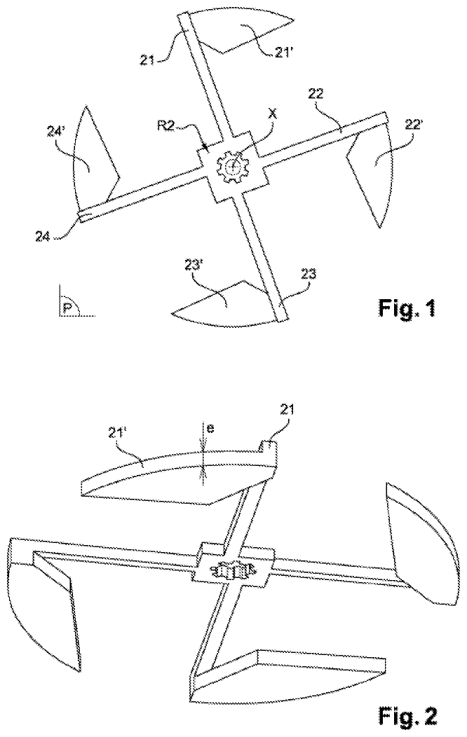

FIG. 1 is a schematic front view illustration of an embodiment example of one of the two separate portions of the wheel system according to the invention,

FIG. 2 represents the same part that is illustrated in FIG. 1, in a slightly inclined profile view,

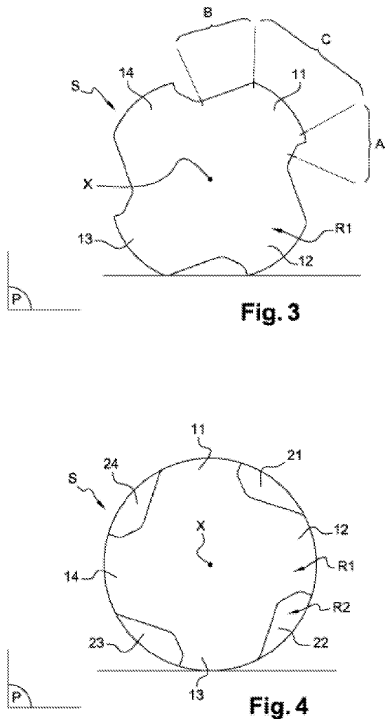

FIG. 3 is a schematic front view illustration of an embodiment example of the other of the two separate portions of the wheel system according to the invention,

FIG. 4 is a schematic front view illustration, in particular from the front, of an embodiment example of a wheel system according to the invention, in the standard position

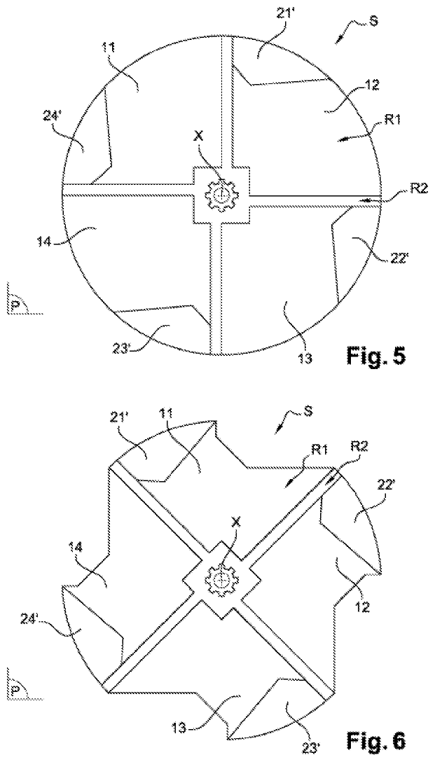

FIG. 5 is the same illustration as in FIG. 4, but of the back,

FIG. 6 is a schematic illustration of the same embodiment example as that illustrated in FIG. 5, in the raised position,

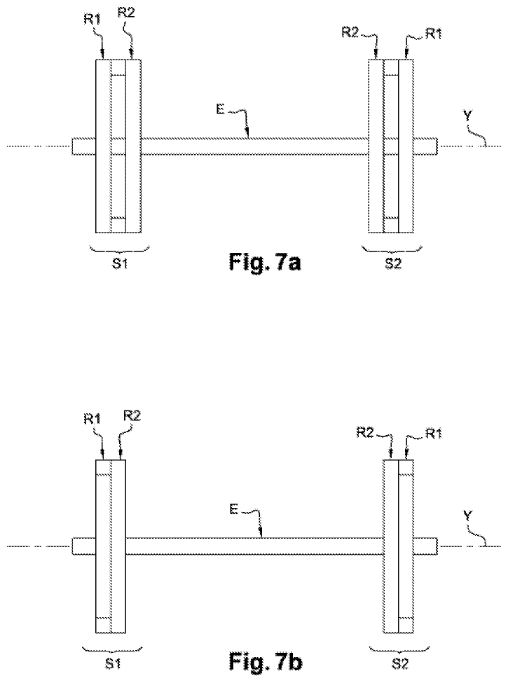

FIGS. 7a and 7b are schematic illustrations of an embodiment example of one single axle of a transport device according to the invention on which two wheel systems according to the invention are assembled, in the raised position and the standard position respectively,

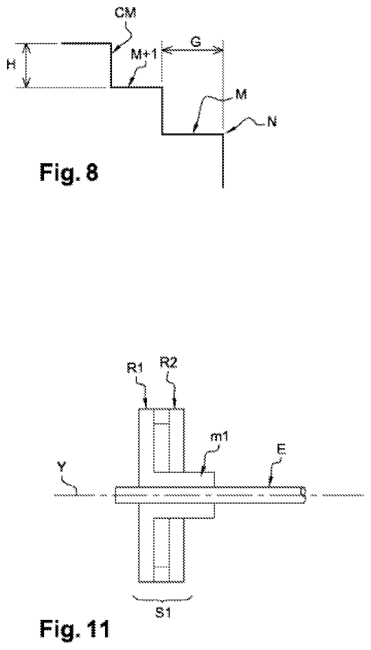

FIG. 8 is a diagram that makes it possible to summarise the vocabulary usually used for a staircase,

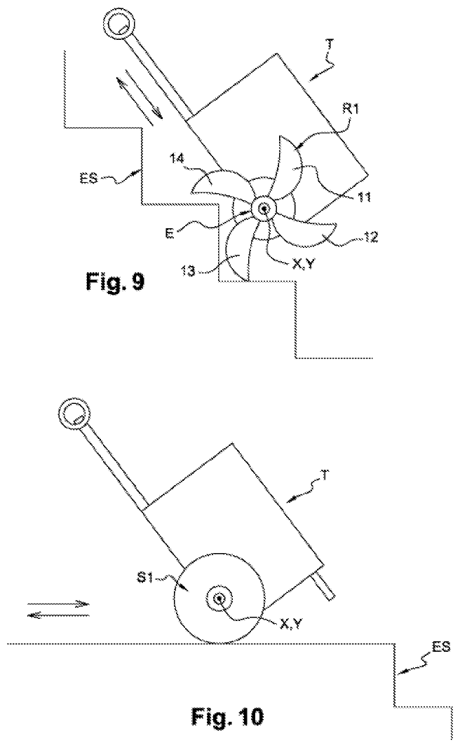

FIG. 9 schematically illustrates an embodiment example of a transport device according to the invention provided with at least one wheel system according to the invention, in the raised position,

FIG. 10 schematically illustrates the same example as that illustrated in FIG. 9, the wheel system being in the standard position,

FIG. 11 is a schematic illustration of the embodiment wherein one separate portion is mounted on the hub of the other separate portion, the wheel system being in the raised position.

As illustrated in FIGS. 4 to 6, the invention relates to a wheel system S intended to be driven in rotation about an axis called the central axis X, comprising two separate portions R1, R2, the two separate portions R1, R2 being arranged to form a pivoted connection with respect to each other about the central axis X.

According to the invention, the wheel system S is designed so as to occupy two positions.

The first position, called the raised position, is illustrated particularly in FIG. 6. In this position, the two separate portions R1, R2 are superposed so as to form branches 11-14, 21-24 that extend radially from the central axis X, in a plane P perpendicular to the central axis X.

In this case, a “plane P perpendicular to the central axis X” means the plane of the sheet of paper for FIGS. 4 to 6.

The orthogonal projection of the separate portions R1, R2 in this plane P, when the wheel system S is in the raised position, only shows one of the two separate portions R1. Indeed, in this position, one separate portion R1 entirely covers the other separate portion R2 and thus forms branches or arms 11-14 (see FIG. 6). The separate portion that is visible then depends on the position of the user with respect to the perpendicular plane P. If they observe the wheel system S in the raised position at the front, they will only see the separate portion R1, the other portion R2 then being hidden. If they observe the wheel system S in the raised position at the back, they will also see the separate portion R2, the other portion R1 still being partially visible (see FIG. 6).

The second position, called the standard position, is illustrated particularly in FIG. 4. In this position, the two separate portions R1, R2 are offset at an angle from each other about the central axis X so as to form a solid disc in the plane P perpendicular to the central axis X defined above. The orthogonal projection of the separate portions R1, R2 in this plane P, when the wheel system S is in the standard position, shows the two separate portions R1, R2, that the wheel being observed from the front side (see FIG. 4) or the back side (see FIG. 5).

The periphery of the separate portions R1, R2 defines a circle in this perpendicular plane P.

We will call first separate portion R1 the portion illustrated in FIG. 3. This first separate portion R1 in this view is shown solid P. However, it is possible to provide cavities in the material in each of the branches 11-14 to reduce the weight thereof, without moving away from the scope of the invention. The first separate portion R1 will preferably have one single material thickness.

The wheel system S according to the invention will comprise, for example, a mechanical and/or electromagnetic device (not illustrated here) intended to pass from the raised position to the standard position and/or from the standard position to the raised position.

This device makes it possible for the relative rotation of the first separate portion R1 with respect to the other separate portion R2, subsequently called the second separate portion.

This device advantageously makes it possible to angularly move, about the central axis X, of the first and second separate portions R1, R2 with respect to each other.

In the scope of the example illustrated here, with four branches 11-14, 21-24 for each of the separate portions R1, R2, this rotation is provided to drive one of the separate portions R2 in movement by about 45°, with respect to the other R1.

As illustrated in FIGS. 1 and 2, the second separate portion R2 will comprise branches or arms 21-24, of which the ends, particularly the distal ends, are protrusions 21′-24′ offset from the plane that contains said branches 21-24. Thus, in FIG. 1, the protrusions 21′-24′ are in the same plane as the plane P of the sheet of paper, while the branches 21-24 are in a plane raised by a thickness e that is the thickness of the protrusions 21′-24′ (see FIG. 2).

Thus, with regard to the particular shape of the second separate portion R2, the passage from the raised position to the standard position—and reciprocally from the standard position to the raised position—is also made by means of a translational movement along the central axis, of one of the separate portions with respect to the other. Therefore, this translation movement is added to the pivotal movement about the central axis X and it is a sliding pivotal connection that exists between the two separate portions R1, R2 to control the passage from the raised position to the standard position and reciprocally.

This is why the mechanical and/or electromagnetic device mentioned above will also advantageously perform a relative translational movement of the first separate portion R1 with respect to the other portion R2, along the central axis X. The protrusions 21′-24′ will advantageously be integral with the branches 21-24.

The protrusions 21′-24′ can also be made from a material different from that of the branches 21-24 and therefore fixed to the free end of said branches 21-24 in a second time.

As an example (not illustrated), the device comprises at least one electromagnetic suction cup and an electric motor.

The electromagnetic suction cup is designed to move the second separate portion R2 in translation along the central axis X with respect to the first separate portion R1, by magnetic attraction, between the standard position and a so-called intermediate position, when said electromagnetic suction cup is in an active state.

To achieve this, the second separate portion R2 comprises for example one or more portions made of a magnetic material. For example, the second separate portion R2 can be provided from a counterplate made from a metallic material.

When the wheel system S is in the intermediate position, the second separate portion R2 is arranged opposite the first separate portion R1 with respect to the plane P and in contact with the electromagnetic suction cup.

In the intermediate position, the first separate portion R1 and the second separate portion R2 are further angularly offset with respect to one another.

The second separate portion R2 is for example held in contact with the electromagnetic suction cup, when the wheel system S is in the raised position. In other words, the electromagnetic suction cup remains in the active state when the wheel system S passes from the intermediate position to the raised position and when the wheel system S is in the raised position.

The electromagnetic suction cup is further designed to release the magnetic attraction made on the second separate portion R2, when said electromagnetic suction cup is in an inactive state.

The electromagnetic suction cup may for example be intended to be mounted on a frame of the transport device T comprising the wheel system S.

The electric motor is designed to pivot the first separate portion R1 about the central axis X with respect to the second separate portion R2, between the intermediate position and the raised position, when said motor is in an active state.

For example, the motor is intended to be mounted on a frame of the transport device T comprising the wheel system S.

The device can further comprise elastic return means designed to move the second separate portion R2 in translation along the central axis X with respect to the first separate portion R1, towards the first separate portion R1 when the electromagnetic suction cup is in the inactive state. Thus, when the electromagnetic suction cup releases the magnetic attraction applied on the second separate portion R2, and the wheel system S is in the intermediate position, the second separate portion R2 moves to the standard position.

For example, the elastic return means comprise one or more compression springs intended to be mounted between the second separate portion R2 and the frame of the transport device T comprising the wheel system S.

Thus, to pass from the standard position to the raised position, the electromagnetic suction cup is firstly activated, so as to move the second separate portion R2 in translation from the standard position to the intermediate position. When the wheel system S is in the intermediate position, the electromagnetic suction cup remains in the active state, thus blocking all translational and rotational movement of the second separate portion R2. The motor itself is then activated so as to drive the first separate portion R1 alone in rotation, the second separate portion R2 being blocked by the electromagnetic suction cup, until reaching the raised position.

Conversely, to pass from the raised position to the standard position, the motor is firstly activated so as to drive the first separate portion R1 alone in rotation, the second separate portion R2 remaining blocked by the electromagnetic suction cup, until reaching the intermediate position. Then, when the wheel system S is in the intermediate position, the electromagnetic suction cup releases the magnetic attraction applied on the second separate portion R2. The second separate portion R2 then moves to the standard position under the effect of the elastic return means.

As a variant, the electromagnetic suction cup can also be designed to move the second separate portion R2 by magnetic attraction in an inactive state and to release said magnetic attraction in an active state.

For example, the device comprises at least one pair of electromagnetic suction cups placed so as to come in contact with portions of the second separate portion R2 arranged diametrically opposite each other about the central axis X, when the wheel system S is in the intermediate position and in the raised position.

It is useful to note that the device, either mechanical and/or electromagnetic is activatable from the exterior, for example remotely.

To achieve this, the wheel system S according to the invention may advantageously comprise an electronic device (not shown here) to control the passage from the raised position to the standard position and/or from the standard position to the raised position.

It is also useful to note that the two separate portions R1, R2 are different in their shape and dimensions so as to be complementary, particularly in the raised position.

More specifically, the first separate portion R1, R2 is in the form of an independent cross R1 called the support cross R1 and comprising a plurality of branches 11-14.

As illustrated in FIG. 3, the branches 11-14 will advantageously have the same functional profile allowing them to grip and/or accompany a rotational movement of the wheel system S, in the raised position when the wheel system stops in contact with a riser CM or a stair nosing N of a staircase.

FIG. 8 illustrates what is meant by riser CM, stair nosing N, step M, tread G and step height H.

FIG. 3 comprises markers A, B and C at the level of one of said branches 11. These three zones are functional zones A, B, C:
the zone referenced A is used as a grip on the step, close to the stair nosing N,
the zone referenced C corresponds to a circular part which is intended to engage on the step M, by rolling on it,
the zone referenced B is a portion that prevents the grip from being made on the next step M+1 and/or a portion that facilitates the tipping of the wheel system S when it comes into contact with a riser CM.

Advantageously, the functional profile of the support cross R1 comprises cavities and reliefs that alternate around the periphery thereof.

“Cavity” means the absence of material corresponding to zones A/B between two successive branches 11-14 around/on the periphery of the first separate portion/rolling cross R1. “Relief” means material corresponding to zones C around/on the periphery of the first separate portion/rolling cross R1.

The second R2 of the two separate portions R1, R2 is itself in the form of an independent cross called the rolling cross R2 and comprising a plurality of branches 21-24.

As mentioned above, the branches 21-24 are designed to engage with the cavities and reliefs of the functional profile of the support cross R1, particularly by means of protrusions of material 21′-24′ described above. More specifically, these protrusions of material 21′-24′ are intended to fill the cavities of the functional profile of said support cross R1, particularly when the system is in the raised position (see FIGS. 4 and 5). In other words, these protrusions of materials 21′-24′ are designed to fill in the cavities formed between two successive branches 21-24 of the first separate portion R1.

Also, in other words, the second separate portion R2 is made from branches 21-24 that support protrusions of material 21′-24′ at the distal end thereof, or the free end thereof, the protrusions 21′-24′ being added onto the branches 21-24.

Also, in other words, each of the protrusions 21′-24′ forms an excess thickness e with respect to the branches 21-24 (see FIG. 2). In the raised position, said excess thicknesses e fill in the cavities of the profile of the support cross R1, the branches 21-24 thus coming into contact with the support cross R1.

It must be noted that the example illustrated here relates to the crosses R1, R2 each with four branches 11-14, 21-24, which explains the angular offset movement of around 45° between the crosses R1, R2.

The number of four branches 11-14, 21-24 is not limiting. There could be three, even five, six, seven or eight. The required angular offset of one cross R1 with respect to the other cross R2 will be calculated accordingly, so as to form the disc described above when the wheel system S is in the standard position.

It must also be noted that said first separate portion R1 can advantageously comprise chamfered edges at the cavities and/or the reliefs around the periphery thereof, preferably at the cavities, so as to facilitate the entry of protrusions of materials 21′-24′ at said cavities when the wheel system S passes from the raised position to the standard position.

As illustrated in FIGS. 7a and 7b, the invention also relates to a transport device T equipped with at least two wheel systems S1, S2 described above, the wheel systems S1, S2 being assembled along one single and same axis Y called the rotation axis of the wheel systems S1, S2 of the transport device T. This rotation axis Y of the wheel systems S1, S2 of the transport device T is coincident with the central axis X defined above.

The wheel systems S1, S2 can advantageously be assembled on one single axle E (example illustrated on FIGS. 7a and 7b) or on one axle for each wheel system S1, S2 (example not illustrated).

The functioning of the wheel system S according to the invention will now be described with reference to FIGS. 9 and 10 that illustrate an example of a transport device T in a phase to climb an obstacle such as a staircase (FIG. 9), and then a rolling phase on a flat surface, or a surface without obstacles (FIG. 10).

A wheel system S1, S2 is placed on each side of the rotation axis Y of the transport device T.

When exiting a staircase ES, the wheel system S, then in the raised position, must pass to the standard position.

In the raised position, the separate portions R1, R2 are offset to let the first separate portion R1 bear on the steps M.

When reaching a flat surface, one of the separate portions R2 or the rolling cross R2 of each wheel system S1, S2 pivots by an angle of about 45°, then translates along the axis X thereof to engage the protrusions of material 21′-24′ of the rolling cross R2 in the cavities of the support cross R1, while the other separate portion R1, or the support cross R1, remains in contact with the ground so as, after pivoting about the central axis X and then translation along the same axis, to form a solid and standard wheel with the periphery of the two crosses R1, R2 thus deployed.

When arriving in front of a staircase ES, the wheel system S, then in the standard position, must pass to the raised position.

In the standard position, the separate portions R1, R2 form a solid wheel.

To pass to the raised position, one of the separate portions R2 or the rolling cross R2 of each wheel system S1, S2 translates along the axis X thereof to move the protrusions of material 21′-24′ out of the rolling cross R2, outside the cavities of the support cross R1, and then pivots by an angle of about 45°, while the support cross R1 remains in contact with the ground so as, after translation along the central axis X and then pivoting about the same axis X, to form a wheel that could be considered as a star wheel.

It must be noted that the two crosses R1, R2 of one single system S can rotate directly on the axle E, or can rotate one on the other, via an intermediate hub without moving away from the scope of the invention.

FIG. 11 schematically illustrates a separate portion R2 that is mounted on the hub m1 of the other separate portion R1. In other words, the rolling cross R2 is articulated on the support cross R1 that will act as a driving cross due to it being directly engaged with the axle E. Also, in other words, the rolling cross R2 is articulated on the hub m1 of the support cross so as to move the wheel system S1 illustrated in FIG. 11 from the raised position to the standard position and/or from the standard position to the raised position.

It must also be noted that the wheel systems S1, S2 can advantageously be designed to be removably assembled to said transport device T, without using external tools, for example by means of a mechanical or electromechanical coupling system, with the transport device T.

It must also be noted that the transport device T according to the invention advantageously comprises a transport chair for a person with reduced mobility and/or a receptacle designed for the transport of various objects and/or forks, such as a two-wheel hand truck, for the transport of large objects.

FIGS. 9 and 10 illustrate a transport device T of the suitcase type.

It must also be noted that the transport device T according to the invention comprises at least one motor intended to drive the axle E or the axles of the transport device T in rotation. More specifically, the motor is coupled to the axle(s) E so as to turn at least one of the two crosses R1, R2 of one same wheel system S. Said motor can further act as a motor for the mechanical and/or electromagnetic device.

The transport device T can further comprise a lifting system (not illustrated) intended to be activated when passing the wheel system(s) S1, S2 from the raised position to the standard position and/or from the standard position to the raised position, particularly so as to facilitate the passage between these two positions, said lifting system being configured to bear on the ground while being activated so as to lift the wheel system(s) S1, S2 off the ground.

As an example (not illustrated), the lifting system comprises an electric actuator connected firstly to a frame of the transport device T and secondly to the axle E through one or more articulated rods, and a pad mounted on a frame of the transport device T. The actuation of the actuator makes it possible to drive the axle E and therefore the wheel system(s) S1, S2 to pivot them, while the pad bears on the ground, so as to lift the wheel system(s) S1, S2 off the ground and thus facilitate moving the wheel system(s) S1, S2 from the raised position to the standard position or from the standard position to the raised position.

As an example, the dimensions of the crosses R1, R2 will be selected so as to form a wheel system in the standard or extended position, forming a disc with an outside diameter of around 48 cm. These dimensions are mainly controlled by the height H of the steps of a staircase ES, and less by the tread G of the steps (often standard). They are also advantageous for rolling on rough ground.

For the sake of precision, the external end C of the branches 11-14, 21-24 of crosses R1, R2 must be around one eighth of a circle, particularly so as to form a complete circle when the wheel system 10 is in the standard position.

Also, for the sake of precision, the side A of the branches 11-14 is intended to grip on the step M is curved, particularly to facilitate the grip thereof on abnormally high steps.

It is useful to note that when the transport device T according to the invention comprises a transport chair for a person with reduced mobility, this makes it possible for an accompanying third party to pull a person seated in their chair to the top of a staircase, or even better, if the chair is motor-driven and/or robotised, to climb the staircase without any effort.

One of the advantages of providing robotisation of a transport device T according to the invention consists of avoiding the tipping of said device T towards the bottom of the staircase ES.

The transport device T can also be used on an exploration machine, for example a remotely guided machine.

It must also be noted that variant embodiments are possible, of course. In particular, it is also possible in additional embodiment examples to provide an electronic system to manage the drive motor for the axle(s) E, when climbing a staircase.
This electronic system would comprise a plurality of sensors, particularly:
a first sensor placed in the portion B of a branch 11 (see FIG. 3) to detect a riser CM and thus trigger a process to start the motor, this process will advantageously comprise a calculation step to move the wheel system S in the lifting position to a distance from the riser CM, particularly by an appropriate distance, such that after a first rotation of the wheel system S, particularly one eighth of a circle, the wheel system S does not strike the next riser as it rotates,
a second sensor placed in the portion C, particularly at the centre of the circular arc C, of the branch 12 intended to rest on the step M above the riser CM detected by the first sensor and that will trigger stopping the motor when the portion of this branch 12 rests entirely on the step M.

Also for sake of precision, the so-called raised position could have been called the climbing/descending position, without moving away from the scope of the invention.

1. A wheel system intended to be driven in rotation about a central axis, the system comprising:
two separate portions arranged to form a pivoted connection with respect to each other about the central axis,
wherein the wheel system occupies two positions, the two positions comprising:
a raised position wherein the two separate portions are superposed so as to form branches in a plane perpendicular to the central axis, branches that extend radially from the central axis, one separate portion then entirely covering the other separate portion, and
a standard position wherein the two separate portions are angularly offset from each other about the central axis, so as to form a disc in the plane perpendicular to the central axis, particularly a solid disc, the passage from the raised position to the standard position—and reciprocally from the standard position to the raised position—taking place by way of a translational movement, along the central axis, of one of the separate portions with respect to the other.

2. The wheel system according to claim 1, further comprising a mechanical and/or electromagnetic device intended to ensure the passage from the raised position to the standard position and/or from the standard position to the raised position, and/or an electronic device to control the passage from the raised position to the standard position and/or from the standard position to the raised position.

3. The wheel system according to claim 1, wherein the two separate portions are different in their shape and dimensions so as to be complementary, particularly in the standard position.

4. The wheel system according to claim 3, wherein a first of the two separate portions is in the form of an independent support cross, the support cross comprising a plurality of branches, the branches having a functional profile allowing them to grip and/or accompany a rotational movement of the wheel system, in the raised position, when the wheel system abuts with a riser or stair nosing of a staircase, said functional profile comprising cavities and reliefs alternating around the periphery of said support cross.

5. The wheel system according to claim 4, wherein the second of the two separate portions is in the form of an independent rolling cross, the rolling cross comprising a plurality of branches, the branches being designed to engage with the cavities and the reliefs of the functional profile of said support cross.

6. The wheel system according to claim 4, wherein the branches of said second separate portion comprise protrusions of material near the distal end thereof intended to fill in the cavities of the functional profile of said first separate portion, particularly when the system is in the standard position.

7. The wheel system (S) according to any one of claims 4 to 6, wherein said first separate portion (R1) comprises chamfered edges at the level of the cavities and the reliefs around the periphery thereof.

8. A transport device comprising:
at least one wheel system assembled along rotation axis of the wheel system of the transport device, the wheel system occupying two positions, the two positions comprising:
a raised position wherein the two separate portions are superposed so as to form branches in a plane perpendicular to the central axis, branches that extend radially from the central axis, one separate portion then entirely covering the other separate portion, and
a standard position wherein the two separate portions are angularly offset from each other about the central axis, so as to form a disc in the plane perpendicular to the central axis, particularly a solid disc, the passage from the raised position to the standard position—and reciprocally from the standard position to the raised position—taking place by way of a translational movement, along the central axis, of one of the separate portions with respect to the other.

9. The transport device according to claim 1, wherein the transport device is a transport chair for a person with reduced mobility.

10. The transport device according to claim 1, further comprising a lifting system intended to be activated when passing at least one wheel system from the raised position to the standard position and/or from the standard position to the raised position, particularly so as to facilitate the passage between these two positions, said lifting system being configured to bear on the ground while being activated so as to lift the wheel system above the ground.
